(19) United States
(12) Patent Application Publication
(10) Pub. No.: US 2005/0076889 A1
(43) Pub. Date: Apr. 14, 2005

(54) FUEL CONDITIONING DEVICE

(76) Inventor: Julian B. Melendrez, North Las Vegas, NV (US)

Correspondence Address: SIMPSON & SIMPSON, PLLC, 5555 MAIN STREET, WILLIAMSVILLE, NY, 14221-5406, US

(21) Appl. No.: 10/605,623

(22) Filed: Oct. 14, 2003

(51) Int. Cl. F02M 27/04

(52) U.S. Cl. 123/538; 210/222

(57) ABSTRACT

A fuel conditioning device and method for conditioning fuel includes at least one magnet with a lower side that is longitudinally disposed adjacent to a fuel line such that the magnet induces a magnetic field proximate the fuel line and into any fuel flowing through the fuel line. The invention further includes at least one metal plate disposed near an upper side of the magnet as well as appropriate means for securing the magnet and the metal plate to the fuel line. The invention may further include one or more focusing bars as described in U.S. Pat. No. 5,271,369 (Melendrez).

### FIELD OF THE INVENTION

The present invention relates generally to fuel systems for combustion engines, and more particularly to a device for conditioning fuel to improve and increase internal combustion engine fuel efficiency.

### BACKGROUND OF THE INVENTION

Permanent magnets have, in the past, been attached to fuel lines on internal combustion engines for purposes of increasing fuel economy. The specific mechanisms of how the magnets increase fuel economy is not fully understood, but it is believed that a magnetic field realigns the available oxygen atoms with the hydrogen atoms within the hydrocarbon molecules to increase their affinity for oxygen, which produces more complete combustion of fuel in the cylinders of the engine.

Others, including the present patentee, have developed magnet assemblies for conditioning fuel for purposes of increasing the fuel efficiency of engines. For example, U.S. Pat. No. 5,080,080 (Melendrez), which application is incorporated herein by reference, discloses one or more magnets disposed adjacent a longitudinal portion of a fuel line and a shielding means of rubber for surrounding the magnet and the fuel line. U.S. Pat. No. 5,271,369 (Melendrez), which application is incorporated herein by reference, discloses a device similar to that described in the '080 patent above, which further comprises a focusing bar that is disposed on the side of a fuel line opposite one or more magnets. Another system is described in U.S. Pat. No. 4,461,262 (Chow) and includes a first pair of magnets sandwiched about a fuel inlet line and a second pair of magnets sandwiched about a carburetor air intake. For each pair of magnets, like magnetic poles (e.g., both south poles) are aligned and diametrically opposite to one another, with the north pole being located toward the carburetor mixing zone so both the fuel and the air first flow between the two south poles, then between the two north poles. A further system described in U.S. Pat. No. 4,572,145 (Mitchell) has a magnet embedded in the upper portion of a plastic body. The plastic body has a pair of legs defining an open groove therebetween, which receives the fuel line. Two straps secure the fuel line within the groove. The magnet is separated from the fuel line by a portion of the plastic body. The plastic body of Mitchell does not surround or shield the fuel line, but rather leaves the lower portion of fuel line exposed to the environment. Another magnetic device is marketed by H. K. Research and Development, 33491 Calle Miramar, San Juan Capsitrano, Calif., as a HK-12 Unit. The H. K. Research and Development magnet is affixed to a standard fuel line by means of nylon straps. Although these units tend to increase the fuel economy of the engine to which they are attached, it has been found that additional increases in the fuel economy of an engine can be realized via the present invention.

What is needed then is a device for increasing the fuel efficiency of an internal combustion engine that is simple and more effective than current means and methods available in the art.

### SUMMARY OF THE INVENTION

The present invention broadly comprises a device and method for conditioning fuel. The device for conditioning fuel includes at least one magnet having a lower side that is longitudinally disposed adjacent a fuel line such that the magnet induces a magnetic field into fuel flowing through the fuel line. The invention further includes at least one metal plate disposed near an upper side of the magnet and means for securing the magnet and the metal plate to the fuel line.

According to the present invention, a fuel line (any type fuel line) transports fuel from an inlet side to an outlet side of the fuel line. The inlet side of the fuel line is connected to a fuel source, such as a fuel tank, fuel pump, or the like, and the outlet side of the fuel line is connected to a carburetor, fuel injection system or other fuel distribution system. A magnet assembly having one or more permanent magnets is secured against the fuel line, which may be installed by the manufacturer, so that preselected particular poles of the lower sides of the one or more magnets are in contact with the fuel line. Disposed proximate the upper sides of the one or more magnets is one or more metal plates, preferably a ferrous metal plate made from a steel alloy. A shield (rubber, plastic, etc.) surrounds the one or more magnets and the one or more metal plates and secures the assembly to the fuel line. The one or more magnets and metal plates direct a magnetic field towards the fuel line to induce a magnetic field into any fuel flowing through the fuel line.

It is therefore an object of the present invention to provide an improved fuel conditioning device for improving the fuel utilization of an internal combustion engine.

Another object of the present invention is to improve the fuel economy and the fuel emissions of an internal combustion engine.

A further object of the present invention is to provide an improved method of conditioning the fuel flowing to an internal combustion engine.

An additional object of the invention is to shield and strengthen a magnetic field induced in a fuel line to improve the utilization of fuel received by an engine through the fuel line.

Still another object of the invention is to condition fuel flowing in a fuel line using a magnetic field to provide more complete combustion of the fuel in an internal combustion engine.

The present invention relates to the above features and objects both individually and collectively and these and other objects, features and advantages of the present invention will become apparent to those skilled in the art upon study of the following detailed description in view of the drawings and claims.

### BRIEF DESCRIPTION OF THE DRAWINGS

FIG. 1 is a perspective view of a fuel conditioning device according to the present invention;

FIG. 2 is an exploded perspective view of an embodiment of a fuel conditioning device of the present invention;

FIG. 3 is a broken perspective view of an embodiment of the invention;

FIG. 4 is a sectional view of an embodiment of the present invention taken generally along line 4-4 of FIG. 1;

FIG. 5 is a broken perspective view of an alternative embodiment of the present invention;

FIG. 6 is a perspective view of another alternative embodiment of the present invention;

FIG. 7 is a broken perspective view of the embodiment of FIG. 6;

FIG. 8 is a broken perspective view of another embodiment of the present invention; and,

FIG. 9 is a sectional view of the embodiment of FIG. 8 taken generally along line 9-9 of FIG. 8.

### DETAILED DESCRIPTION OF THE INVENTION

At the outset, it should be appreciated that like reference numbers on different drawing figures represent similar structural elements. It should also be appreciated that, while a number of different embodiments and variations of the present invention are shown in the various drawings, the invention as claimed is not intended to be limited to these specific embodiments as the claims define a broader invention that can take many different shapes and structures. For example, while rectangular magnets, metal plates and shields operatively arranged to be secured to a fuel line are disclosed herein, it should be appreciated by those having ordinary skill in the art that other shaped and sized magnets, metal plates and shields may be substituted. It should be further appreciated that while a fuel conditioning device is disclosed herein in association with internal combustion engines, the fuel conditioning device of the present invention may be adapted for use with virtually any other device or means wherein fuel is combusted, or otherwise consumed; for example, the present invention may be used in association with heaters, furnaces, fuel cells, etc., or where fuel conditioning may be desired.

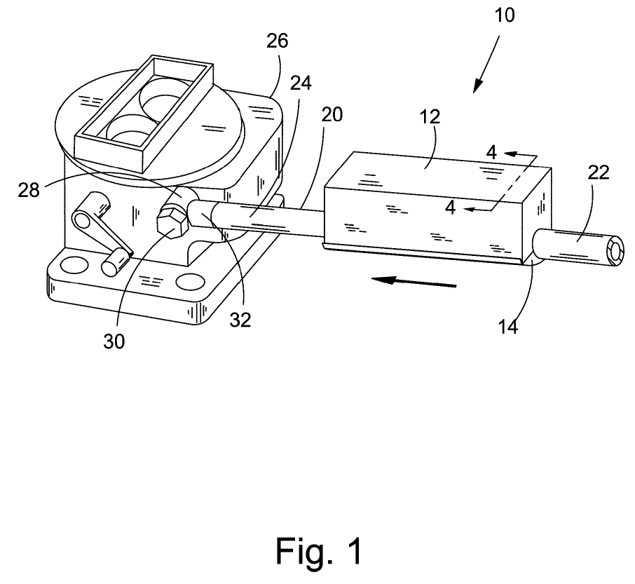

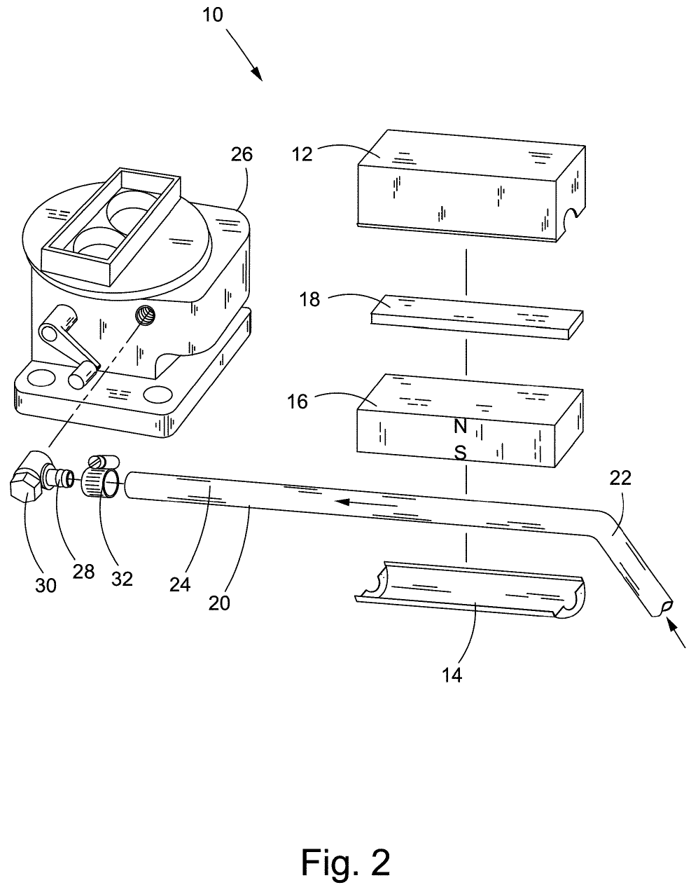

Adverting now to the Figures, FIGS. 1 and 2 illustrate a fuel conditioning device of the present invention comprising magnet assembly 10 operatively arranged for use with a conventional gasoline powered internal combustion engine. It should be appreciated that while the embodiment of FIGS. 1 through 4 is preferably arranged for use with a four cylinder gasoline powered internal combustion engine, such embodiment is utilized herein to broadly illustrate components common to, or similar among, the various embodiments of the present invention. In FIGS. 1 through 4 it is, thus, seen that magnet assembly 10 is operatively arranged to be secured about fuel line 20. Fuel line 20 may comprise that fuel line installed by the manufacturer or a fuel line installed by another. Magnet assembly 10 broadly comprises upper shield 12, lower shield 14, magnet 16 and metal plate 18, which assembly is secured to fuel line 20.

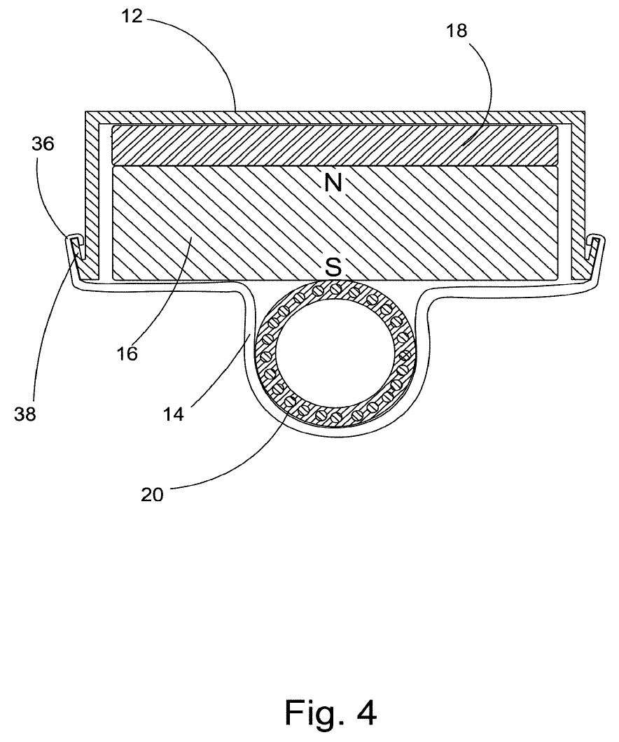

Upper shield 12 and lower shield 14 are provided for forming a housing to protect magnet 16 and metal plate 18 from environmental contaminants such as dirt, water, heat, oils, solvents and the like. Upper shield 12 comprises a cavity for securing magnet 16 and metal plate 18 therein. As shown in FIG. 4, upper and lower shields 12 and 14, respectively, are formed for complementary mateable fit with one another and may secure to one another via snap fasteners 36 and 38 to form a housing about the magnet(s), metal plate(s) and fuel line. The upper and lower shields secure the magnet(s) and metal plate(s) such that movement thereof on or about the fuel line is prevented. Hence, the upper and lower shields comprise shapes that conform to the shape of the fuel line. It should be appreciated by those having ordinary skill in the art that other appropriate housing means or other appropriate means for securing magnet 16 and metal plate 18 proximate the fuel line are encompassed by the present disclosure and claims. For example, the shield could be formed from rubbers, plastics or other composites, or plastic or nylon tie straps, etc. could be utilized to secure the magnet(s) and metal plate(s) to the fuel line.

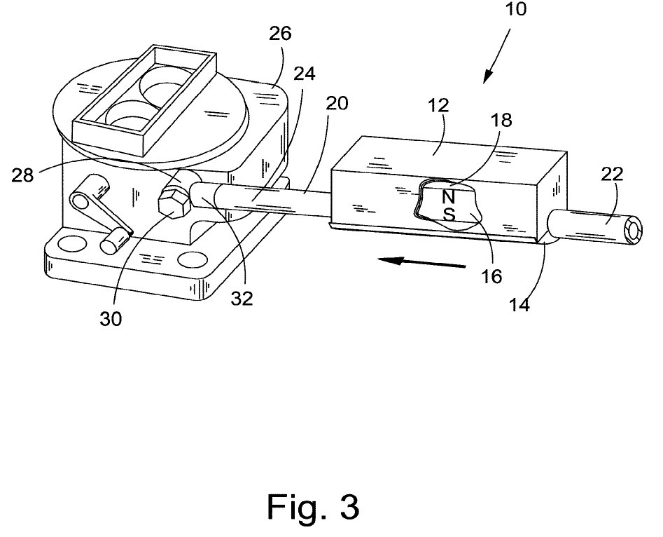

Referring now to FIGS. 3 and 4, magnet 16 has a north pole and a south pole and is arranged proximate the fuel line such that its lower side is adjacent the exterior surface of fuel line 20. In the embodiment shown in FIGS. 1-4, the lower side of the magnet comprises the south pole of the magnet. The magnet's 16 upper side, shown in FIGS. 1-4 as the north pole, faces away from the fuel line 20. The upper side of the magnet has a size (planar area) and shape that is similar to the size and shape of metal plate 18. Magnet 16 is preferably of porcelain or ceramic, and has at least a 2,000 gauss magnetic charge. Of course, magnets having higher or lower magnetic charges may be utilized to achieve varying results as may be desired. It is preferred to use magnet 16 without any coating or covering surrounding the magnet faces. While magnets having plastic, or other, coatings may certainly be utilized, such magnets have been found to be inferior due to the heat within an engine compartment; in such cases, plastic coatings may melt when installed on some engines. Plastic coatings are also believed to decrease the flux produced by the magnet to one half of the rated gauss value. Thus, bare ceramic magnets are preferred.

As indicated above, metal plate 18 is operatively arranged to comprise a size and shape that is similar to the size and shape of the upper side of the magnet. The metal plate is disposed proximate to the upper side of the magnet, and preferably maintains direct contact with the upper side of the magnet. In a preferred embodiment, metal plate 18 has a thin cross-section and comprises a ferrous alloy, preferably a steel alloy. It is believed that the metal plate focuses the magnetic field without increasing the magnetic gauss to create a “supercharge” effect. The “supercharge” effect of the present configuration eliminates the need for additional magnets and/or additional magnet assemblies that are typically used with larger engine types and/or fuel types, i.e., diesel engines. The configuration of the metal plate of the present invention further eliminates certain requirements with regard to the location at which the magnet assembly is placed upon the fuel line relative to the fuel distribution means, as is typically required with other assemblies.

Fuel line 20 is operatively arranged for passing fuel from a fuel source to fuel distribution means 26 in the direction shown by the arrows. Hence, fuel line 20 comprises fuel inlet end 22, which receives fuel from the fuel source, such as a fuel pump or fuel tank, and fuel outlet end 24, which connects to fuel distribution means 26 via outlet connector 28. Fuel distribution means 26 may comprise a carburetor, electronic fuel injector or other means for distributing fuel for combustion or consumption.

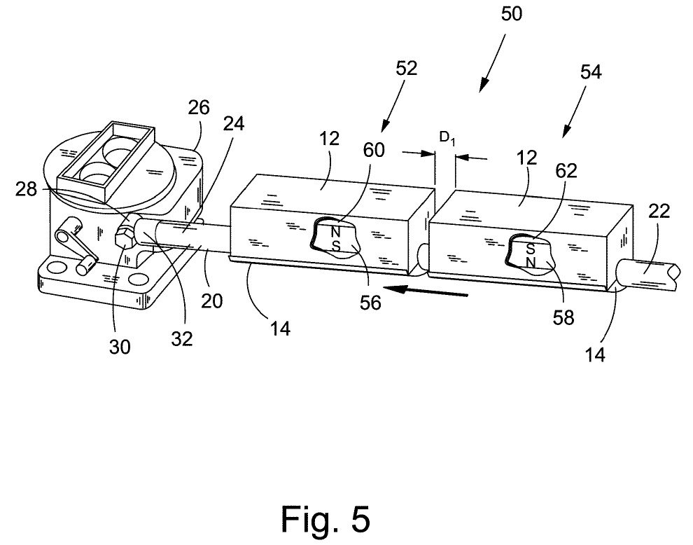

For gasoline powered internal combustion engines comprising more than four cylinders, the present invention may be configured to comprise more than one magnet assembly. For example, FIG. 5 illustrates fuel conditioner 50 operatively arranged for use with a gasoline powered internal combustion engine comprising more than six cylinders. In this embodiment it is seen that fuel conditioning device 50 comprises two magnet assemblies 52 and 54 and that magnet assembly 52 is identical to magnet assembly 10. Magnet assembly 54 is illustrated as being upstream with regard to magnet assembly 52 relative to the direction of fuel flow shown by the arrow. Each magnet assembly 52 and 54 includes at least one magnet 56 and 58, respectively, lying adjacent an exterior surface of the fuel line 20. Each magnet assembly further includes a metal plate, 60 and 62, respectively, associated therewith and disposed on an upper side of each magnet. In the illustrated embodiment, the magnet assemblies each include upper and lower shields 12 and 14, respectively, for substantially surrounding and shielding the magnet and associated metal plates 60 and 62. This embodiment further illustrates that magnet assembly 52 comprises magnet 56, whose lower side adjacent the fuel line is the south pole of the magnet, and magnet assembly 54 comprises magnet 58, whose lower side adjacent the fuel line is the north pole of the magnet. Magnet assembly 54 is also shown as being disposed towards the fuel source such that fuel flowing through fuel line 20 first passes through the magnetic field of magnet 58 and then through the magnetic field of magnet 56. Thereafter, the conditioned fuel is passed onto fuel distribution means 26. It should be further appreciated that magnet assemblies 52 and 54 are longitudinally disposed proximate and side-by-side one another on fuel line 20 such that a space between magnets 56 and 58 having a distance D1 is formed therebetween. The distance D1 formed between the two magnets may vary as may be desired or according to the engine type. For example, where fuel conditioner 50 is configured for use with a six-cylinder gasoline powered engine, the preferred distance between magnets 56 and 58 is approximately 3/4 inches. Alternatively, where fuel conditioner 50 is configured for use with an eight-cylinder gasoline powered engine, the preferred distance between magnets 56 and 58 is approximately 1 and 1/4 inches. In such embodiments, a spacer (not shown) may be disposed between the two magnet assemblies to secure them to one another and to ensure that the proper distance between the magnets is maintained.

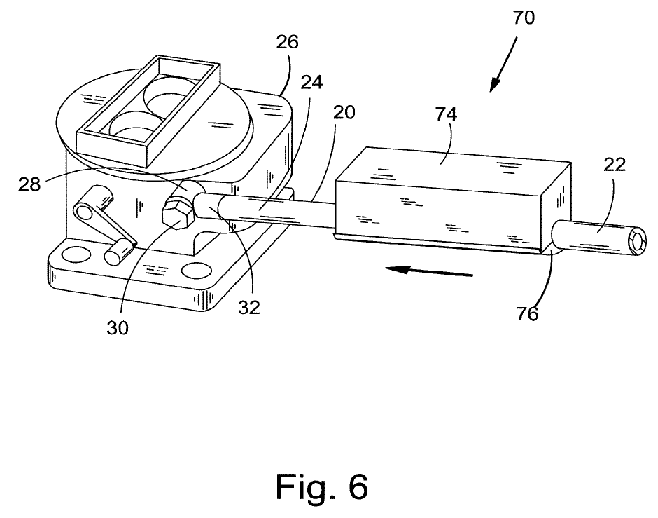

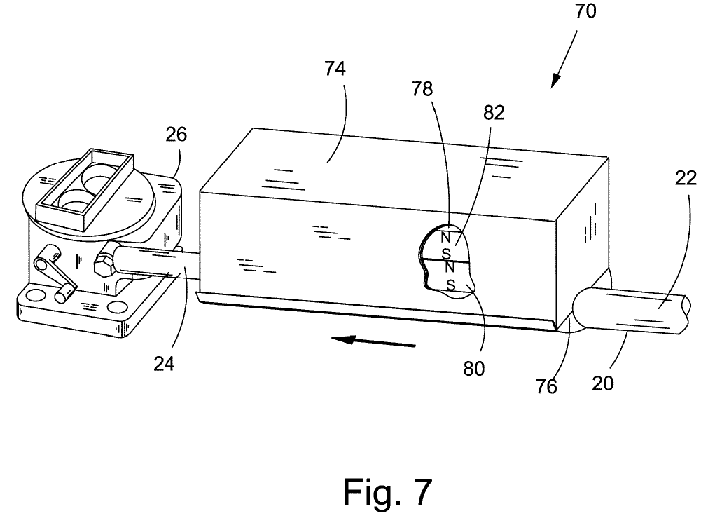

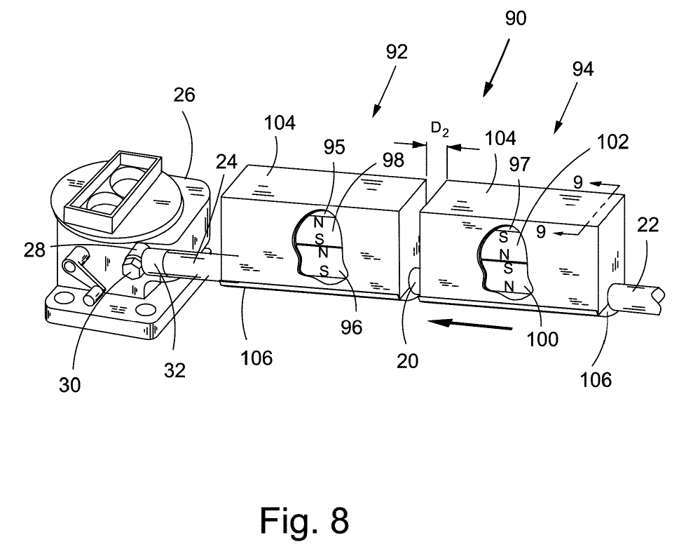

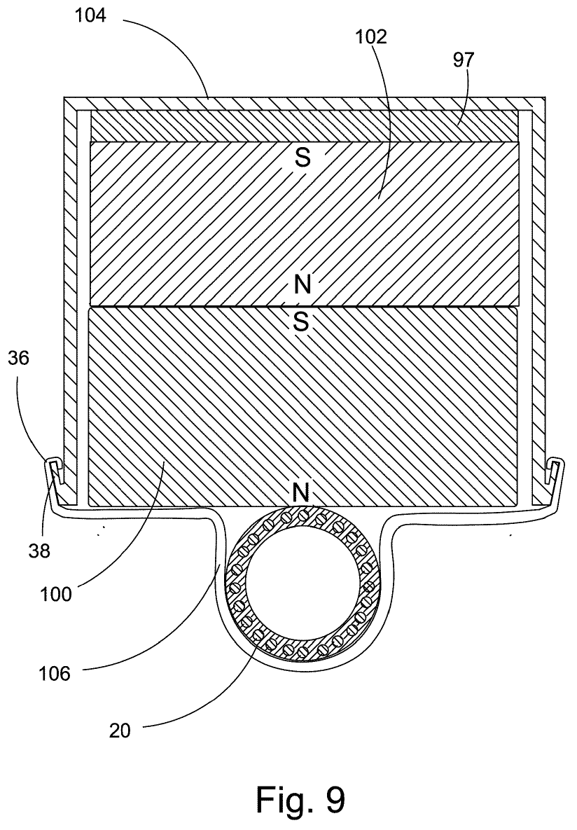

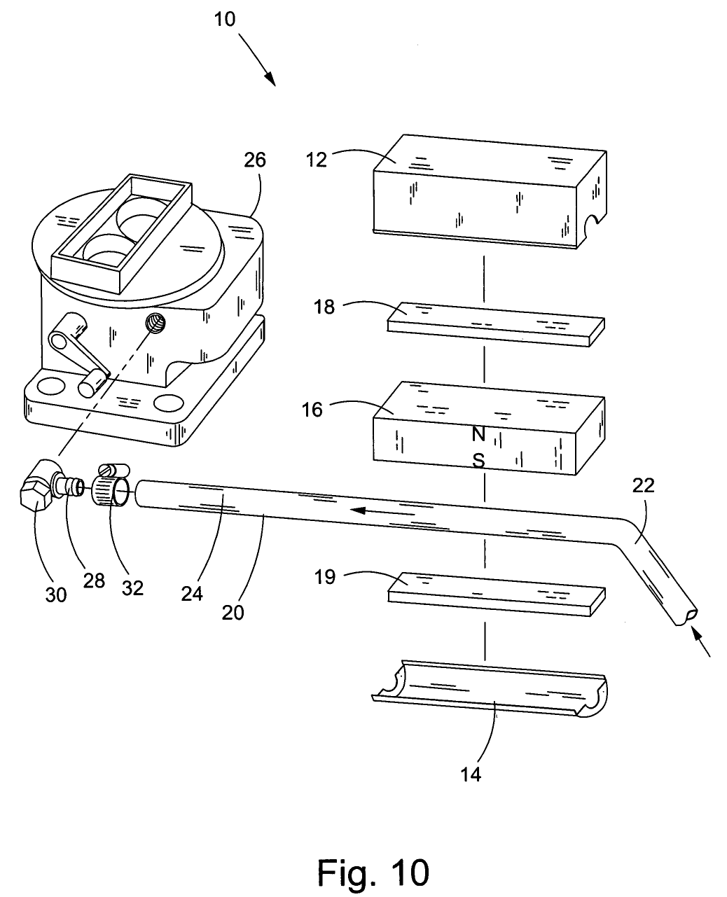

Referring now to FIGS. 6-9, which illustrate additional embodiments of the fuel conditioning device of the present invention operatively arranged for use with diesel powered internal combustion engines. More specifically, FIGS. 6 and 7 illustrate that magnet assembly 70 of the present invention is operatively arranged for use with four-cylinder diesel internal combustion engines and FIGS. 8 and 9 illustrate embodiments of the present invention operatively arranged for use with diesel powered internal combustion engines having more than six cylinders.

In FIGS. 6 and 7 it is seen that magnet assembly 70 is similar to the previously discussed embodiments configured for use with gasoline powered engines in that magnet assembly 70 is secured about fuel line 20 and comprises upper shield 74, lower shield 76, and a metal plate 78. However, this embodiment comprises a pair of magnets 80 and 82 disposed in stacked magnetically attractive arrangement such that magnet 82 is located above magnet 80. Metal plate 78 is, thus, disposed proximate an upper side of magnet 82 and the lower side of magnet 80, which corresponds to the south pole of the magnet, is longitudinally adjacent the fuel line 20. In this embodiment it should be further appreciated that upper shield 74 is similar to upper shield 12, but comprises a cavity adapted to secure both magnets 80 and 82 as well as metal plate 78. Lower shield 76 is virtually identical to lower shield 14, discussed supra. Additionally, it should be appreciated that in this embodiment, the upper and lower shields are adapted for complementary mateable fit with one another to form a housing and may be secured to one another by means of snap fasteners or other appropriate fasteners.

As shown in FIGS. 8 and 9, for diesel powered internal combustion engines having more than four cylinders, the present invention may be configured to comprise more than one magnet assembly. In such embodiment, it is seen that fuel conditioner 90 comprises two magnet assemblies 92 and 94 and that magnet assembly 92 is identical to magnet assembly 70 discussed supra. Magnet assembly 94 is illustrated as being upstream with regard to magnet assembly 92 relative to the direction of fuel flow shown by the arrow. Each magnet assembly 92 and 94 includes at least two magnets and the magnet assemblies lay adjacent an exterior surface of the fuel line 20. Each magnet assembly 92 and 94 includes a metal plate, 95 and 97, respectively. Magnet assembly 92 comprises magnet 96, disposed proximate fuel line 20 such that its lower side, corresponding to the south pole of the magnet, is adjacent fuel line 20, and magnet 98, which is disposed above magnet 96 in magnetically attractive stacked arrangement. Magnet assembly 92 further comprises metal plate 95 which is disposed proximate the upper surface of magnet 98. Magnet assembly 94 comprises magnet 100, disposed proximate fuel line 20 such that its lower side, corresponding to the north pole of the magnet, is adjacent fuel line 20, and magnet 102, which is disposed above magnet 100 in magnetically attractive stacked arrangement. Magnet assembly 94 further comprises metal plate 97 which is disposed proximate the upper surface of magnet 102. In the illustrated embodiment, magnet assemblies 92 and 94 each include upper and lower shields 104 and 106, respectively, for substantially surrounding and shielding the magnets and their associated metal plates. Upper and lower shields 104 and 106 are similar to the upper and lower shields adapted for use with the previously described embodiments of the present invention and each include a cavity for accepting and securing two magnets and a metal plate in stacked arrangement. The shields further include appropriate means for fastening the assemblies to a fuel line. Magnet assembly 94 is also shown as being disposed towards the fuel source such that fuel flowing through fuel line 20 first passes through the magnetic field of magnets 100 and 102 and then through the magnetic fields of magnets 96 and 98. Thereafter, the conditioned fuel is passed onto the fuel distribution means 26. It should be further appreciated that magnet assemblies 92 and 94 are longitudinally disposed proximate and side-by-side one another on fuel line 20 such that a space having a distance D2 is formed therebetween. The distance D2 formed between the magnets may vary as may be desired or according to the engine type. For example, where fuel conditioner 90 is configured for use with a six-cylinder diesel powered engine, the preferred distance between magnets 100, 102 and 96, 98 is 3/4 inches. Alternatively, where fuel conditioner 90 is configured for use with an eight-cylinder diesel powered engine, the preferred distance between magnets 100, 102 and 96, 98 is approximately 1 and 1/4 inches. In such embodiments, a spacer (not shown) may be disposed between the two magnet assemblies to secure the two magnet assemblies to one another and/or to ensure that the proper distance between the magnets is maintained. In the above embodiments, the magnets each comprise a magnetic field strength of at least 2000 gauss. It should be appreciated, however, that magnets having other field strengths may be utilized to achieve results as may be desired.

Finally, it should be appreciated that any one of the above-described embodiments may also be configured to comprise one or more focusing bars arranged on that side of the fuel line opposite the magnet assemblies as substantially described in U.S. Pat. No. 5,271,369 (Melendrez).

Thus, it is seen that the objects of the present invention are efficiently obtained, although modifications and changes to the invention should be readily apparent to those having ordinary skill in the art, which modifications are intended to be within the spirit and scope of the invention as claimed.

1. A fuel conditioning device comprising:
at least one magnet having a lower side, said magnet longitudinally disposed adjacent a fuel line, and operatively arranged to induce a magnetic field proximate said fuel line;
at least one metal plate disposed on an upper side of said magnet; and,
means for securing said magnet and said metal plate to said fuel line.

2. The fuel conditioning device of claim 1 further comprising a protective shield for covering said at least one magnet and said at least one metal plate.

3. The fuel conditioning device of claim 2 wherein said protective shield is selected from a member of the group consisting of rubber and plastic.

4. The fuel conditioning device of claim 3 wherein said protective shield further comprises said means for securing said device to said fuel line.

5. The fuel conditioning device of claim 1 wherein said securing means comprises at least one strap.

6. The fuel conditioning device of claim 1 wherein said magnet comprises a magnetic field strength of at least 2,000 gauss.

7. The fuel conditioning device of claim 1 wherein said magnet and said metal plate are of approximate size and shape such that substantial registration exists between the upper surface of said magnet and a planar surface of said metal plate.

8. The fuel conditioning device of claim 1 wherein said lower side of said magnet comprises the south pole of said magnet.

9. The fuel conditioning device of claim 1 operatively arranged to be secured to the fuel line of an internal combustion engine.

10. The fuel conditioning device of claim 1 comprising:
at least two magnets; and,
at least two metal plates;
said at least two magnets comprising first and second magnets each associated with one of said at least two metal plates; each of said at least two metal plates disposed on an upper side of said first and second magnets, said first and second magnets and associated metal plates disposed adjacent said fuel line and longitudinally with respect to one another along said fuel line; said first magnet disposed toward a fuel distribution means such that its south pole is adjacent said fuel line and said second magnet disposed toward a fuel source such that its north pole is adjacent said fuel line.

11. The fuel conditioning device of claim 1 comprising:
at least four magnets; and,
at least two metal plates;
said at least four magnets comprising first, second, third and fourth magnets; said third and fourth magnets each associated with one of said two metal plates; said metal plates disposed on an upper side of said third and fourth magnets, said third and fourth magnets each in magnetic attractive registrable contact with said first and second magnets, respectively; said first and second magnets longitudinally disposed with respect to one another along said fuel line, said first magnet disposed toward a fuel distribution means such that its south pole is adjacent said fuel line and said second magnet is disposed toward a fuel source such that its north pole is adjacent said fuel line.

12. The fuel conditioning device of claim 1, said fuel conditioning device arranged for attachment to a fuel line conveying fuel from a fuel source to a fuel distribution means, said fuel conditioning device comprising:
at least one shield substantially surrounding said at least one magnet, said at least one metal plate, and said fuel line; said shield defining a cavity for receiving said magnet and said metal plate.

13. The fuel conditioning system of claim 12 comprising a second magnet, said at least one magnet being longitudinally disposed with respect to said second magnet along said fuel line, said at least one magnet disposed toward said fuel distribution means such that its south pole is adjacent said fuel line, said second magnet is disposed toward a fuel source such that its north pole is adjacent said fuel line, and said shield substantially surrounds said first and second magnet.

14. A fuel conditioning device for attaching to a fuel line conveying fuel from a fuel source to a fuel distribution means, said fuel conditioning device comprising at least a first double magnet assembly; said first double magnet assembly comprising:
a first magnet having a lower side centrally disposed adjacent a longitudinal portion of the fuel line to provide a magnetic field proximate said fuel line;
a second magnet disposed on top of said first magnet in magnetic attraction therewith
at least one metal plate disposed near an upper side of said second magnet; and,
at least one shield substantially surrounding said first and second magnets, said at least one metal plate and said longitudinal portion of said fuel line; said shield defining a cavity for receiving said first and second magnets and said metal plate.

15. The fuel conditioning device of claim 14 wherein said lower side of said first magnet of said first double magnet assembly is disposed toward said fuel distribution means such that its south pole is adjacent said fuel line.

16. The fuel conditioning device of claim 15 comprising a second double magnet assembly, said first and second double magnet assemblies longitudinally adjacent one another along said fuel line such that said second double magnet assembly is disposed toward a fuel source and said first double magnet assembly is disposed toward said fuel distribution means.

17. The fuel conditioning device of claim 16 wherein said lower side of said first magnet of said second double magnet assembly is disposed such that its north pole is adjacent said fuel line and centrally disposed on said fuel line.

18. The fuel conditioning device of claim 1 further comprising a focusing bar disposed adjacent said fuel line on the side of said fuel line opposite said magnet.

19. A fuel conditioning device of claim 1 wherein said lower side of said magnet is centrally disposed adjacent said fuel line.
